(19) United States
(12) Patent Application Publication
(10) Pub. No.: US 2021/0318685 A1
(43) Pub. Date: Oct. 14, 2021

(54) AUTONOMOUS ELECTRIC VEHICLE CHARGING OPTIMIZATION BASED ON LOCATION, COST AND SAFETY USING EDGE COMPUTING

(71) Applicant: International Business Machines Corporation, Armonk, NY (US)

(72) Inventors: Jana H. Jenkins, Raleigh, NC (US); Mohammad Ismail, Toronto (CA); Mauro Marzorati, Lutz, FL (US)

(21) Appl. No.: 16/847,634

(22) Filed: Apr. 13, 2020

(51) Int. Cl. G05D 1/02; G06F 16/29; G06Q 10/04; G06Q 30/00; G06Q 10/06; B60L 53/66; G01C 21/34; B60L 58/12

(52) U.S. Cl. CPC G05D 1/0217; G06F 16/29; G06Q 10/047; G06Q 30/018; B60K 6/28; B60L 53/665; G01C 21/3476; B60L 58/12; G06Q 10/06315

(57) ABSTRACT

A method is provided to find an optimal charging station for an electric vehicle travelling along an intended route. Optimality can be based on various factors including relative cost savings, the distance required to detour to a charging station, a station charging level indicating how fast charging takes place, and a safety rating for a charging station. The detour charging station might be a mobile facility. The charging station information is downloaded to the vehicle's navigation system on a regular basis, e.g., daily. Relative cost savings is considered as a percentage of the cost of a reference charging station that is on the route, i.e., that would incur no detour deviation. The detour distance is considered as a percentage of the overall trip distance. An operator of the electric vehicle can set threshold constraints for these factors, and the factors can have different priorities for determining optimality.

### BACKGROUND OF THE INVENTION

### Field of the Invention

The present invention generally relates to electric vehicles, and more particularly to a method of determining where to recharge an electric vehicle during a trip.

### Description of the Related Art

There has been a growing interest in electric-powered vehicles, particularly cars and trucks, as consumers and businesses have become more interested in lowering fossil fuel emissions and reducing fuel costs, This interest extends to hybrid vehicles that use a combination of internal combustion engines and electric engines. As with gasoline-powered vehicles, electric vehicles must also be regularly refueled, that is, by energizing the rechargeable batteries that power the electric engines. A wide variety of battery configurations and internal charging circuits have been devised to allow batteries to get efficiently recharged without risking dangerous conditions such as overcharging batteries.

Electric vehicles (including hybrids) can be charged from many sources such as a conventional electric outlet in a house, a publicly-accessible recharging facility, or any other external source of electric power compatible with the vehicle's recharging system. While electric recharging stations were previously hard to find, they are becoming more prevalent but still are not as ubiquitous as gas stations. Charging stations can provide a variety of charging options, such as different voltages which affect recharging time. For example, existing charging stations can offer power at 440 volts, 220 volts, or the 110 volts standard to most homes in America.

Another advancement in vehicle technology is the ability of a vehicle to drive on its own, without human control or supervision. Such autonomous vehicles are still being perfected but are already feasible for many applications. Autonomous vehicles use various external sensors in combination with cognitive systems to identify the roadways, traffic features such as signs or intersection lights, and potential hazards. Cognitive systems (sometimes referred to as deep learning or deep thought) are a form of artificial intelligence that uses machine learning and problem solving. For the application of autonomous vehicles, cognitive systems can be trained to learn the rules of the road, anticipate sudden changes in conditions, and recognize and respond to safety concerns such as pedestrians entering a roadway.

### SUMMARY OF THE INVENTION

The present invention in at least one embodiment is generally directed to a method of optimizing a charging location for an electric vehicle during a trip by receiving a proposed route for the trip, i.e., from a starting location to a destination location, identifying a charging station on the proposed route which has a charging cost used as a reference, identifying a set of detour charging stations proximate the proposed route, receiving charging station information regarding each of the detour charging stations including a station location and a station charging cost, receiving station selection constraints including an acceptable route deviation from the proposed route and a minimum cost savings compared to the reference charging cost, monitoring the electric vehicle in real-time to determine that its power charge is below a predetermined threshold at a current location, and selecting an optimal one of the detour charging stations for charging the electric vehicle based on the current location and the charging station information subject to the station selection constraints. The charging information can further include a station safety rating, and the selection constraints can likewise include a minimum safety rating defined by an operator of the electric vehicle. The optimal detour charging station can be based on different priorities for the charging station information; for example, the set of the detour charging stations might be within the acceptable route deviation based on the current location and whose station charging costs yield at least the minimum cost savings, and the optimal detour charging station is chosen as the one which has a lowest detour station charging cost. If multiple alternate stations have the lowest charging cost, the optimal detour station can be the one with the lowest route deviation. In one implementation the charging information further includes a station charging rate indicating how fast a given detour charging station recharges. The acceptable route deviation can be a percentage of a distance of the proposed route, and the minimum cost savings can be a percentage of the reference charging cost.

The above as well as additional objectives, features, and advantages in the various embodiments of the present invention will become apparent in the following detailed written description.

### BRIEF DESCRIPTION OF THE DRAWINGS

The present invention may be better understood, and its numerous objects, features, and advantages of its various embodiments made apparent to those skilled in the art by referencing the accompanying drawings.

FIG. 1 is a block diagram of a computer system programmed to carry out electric vehicle charging optimization in accordance with one implementation of the present invention;

FIG. 2 is a pictorial representation of a cloud computing environment in accordance with one implementation of the present invention;

FIG. 3 is a block diagram of a drive system for an autonomous electric vehicle in accordance with one implementation of the present invention;

FIG. 4 is a block diagram of a navigation system for an autonomous electric vehicle in accordance with one implementation of the present invention; and

FIG. 5 is a screenshot from a navigation system showing a primary route and alternative routes on a road map with indications of charging station locations in accordance with one implementation of the present invention;

FIG. 6 is a chart illustrating the logical flow for an electric vehicle charging optimization process in accordance with one implementation of the present invention.

The use of the same reference symbols in different drawings indicates similar or identical items.

### DESCRIPTION OF THE PREFERRED EMBODIMENT(S)

Self-driving electric and Internet-connected vehicles (e.g., autonomous cars) are already on the roads and expected to grow exponentially around the world. These modern-day cars are environmentally friendly and loaded with the latest and greatest technologies, ranging from great looks to smart controls. However, since they belong to a new era of vehicles, they still lack some basic supporting infrastructure that the old, mature cars enjoyed such as gas stations everywhere, real-time gas rates on popular navigation applications, a human driver making the most economical refueling choice, etc.

It would, therefore, be desirable to devise a method of enabling self-driving electric cars to automatically identify nearby the most optimal station location for charging that is still economical and safe for the passengers. It would be further advantageous if the method could leverage existing computing capabilities such as edge technology and cloud computing. These and other advantages are achieved in various implementation of the present invention by finding electric vehicle recharging stations based on near real-time rates that are updated periodically on-premise (in-vehicle) and based on calculations of optimal cost, location and time on the edge. The recommendation system identifies the optimal locations relative to an intended route and cost of charging so the autonomous vehicle can operate in the most cost-effective manner and get charged at a location that is still safe, subject to various operator preferences or other station selection constraints.

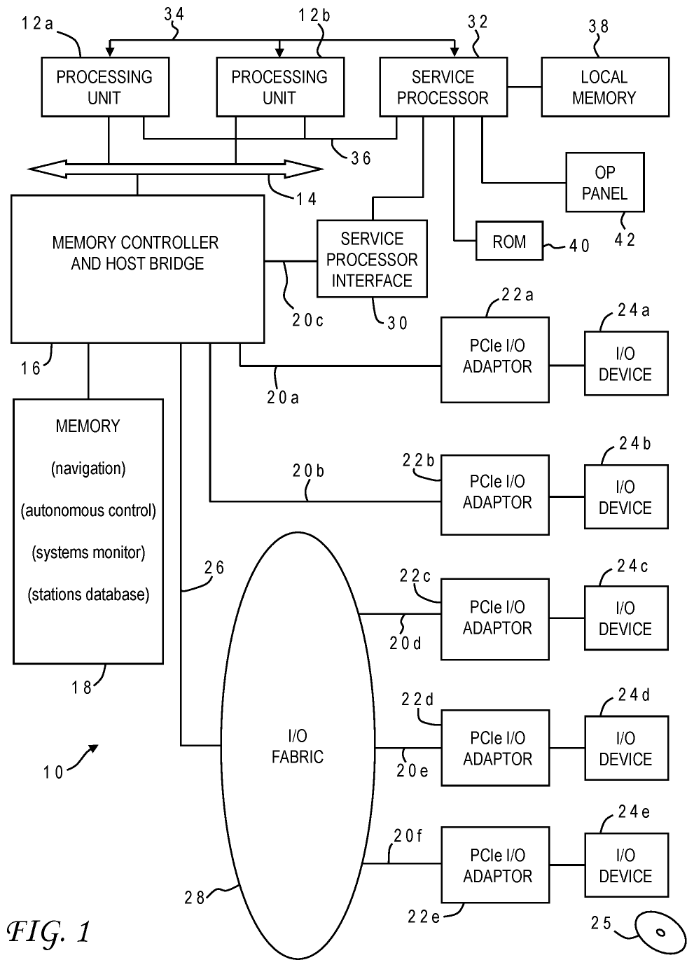

With reference now to the figures, and in particular with reference to FIG. 1, there is depicted one embodiment 10 of a computer system in which the present invention may be implemented to carry out electric vehicle charging optimization. Computer system 10 is a symmetric multiprocessor (SMP) system having a plurality of processors 12a, 12b connected to a system bus 14. System bus 14 is further connected to and communicates with a combined memory controller/host bridge (MC/HB) 16 which provides an interface to system memory 18. System memory 18 may be a local memory device or alternatively may include a plurality of distributed memory devices, preferably dynamic random-access memory (DRAM). There may be additional structures in the memory hierarchy which are not depicted, such as on-board (L1) and second-level (L2) or third-level (L3) caches. System memory 18 has loaded therein one or more applications in accordance with the present invention, including an autonomous control unit, a navigation system, a systems monitor, and a database containing various information pertaining to electric vehicle charging stations.

MC/HB 16 also has an interface to peripheral component interconnect (PCI) Express links 20a, 20b, 20c. Each PCI Express (PCIe) link 20a, 20b is connected to a respective PCIe adaptor 22a, 22b, and each PCIe adaptor 22a, 22b is connected to a respective input/output (I/O) device 24a, 24b. MC/HB 16 may additionally have an interface to an I/O bus 26 which is connected to a switch (I/O fabric) 28. Switch 28 provides a fan-out for the I/O bus to a plurality of PCI links 20d, 20e, 20f These PCI links are connected to more PCIe adaptors 22c, 22d, 22e which in turn support more I/O devices 24c, 24d, 24e. The I/O devices may include, without limitation, a keyboard, a graphical pointing device (mouse), a microphone, a display device, speakers, a permanent storage device (hard disk drive) or an array of such storage devices, an optical disk drive which receives an optical disk 25 (one example of a computer readable storage medium) such as a CD or DVD, and a network card. Each PCIe adaptor provides an interface between the PCI link and the respective I/O device. MC/HB 16 provides a low latency path through which processors 12a, 12b may access PCI devices mapped anywhere within bus memory or I/O address spaces. MC/HB 16 further provides a high bandwidth path to allow the PCI devices to access memory 18. Switch 28 may provide peer-to-peer communications between different endpoints and this data traffic does not need to be forwarded to MC/HB 16 if it does not involve cache-coherent memory transfers. Switch 28 is shown as a separate logical component but it could be integrated into MC/HB 16.

In this embodiment, PCI link 20c connects MC/HB 16 to a service processor interface 30 to allow communications between I/O device 24a and a service processor 32. Service processor 32 is connected to processors 12a, 12b via a JTAG interface 34, and uses an attention line 36 which interrupts the operation of processors 12a, 12b. Service processor 32 may have its own local memory 38, and is connected to read-only memory (ROM) 40 which stores various program instructions for system startup. Service processor 32 may also have access to a hardware operator panel 42 to provide system status and diagnostic information.

In alternative embodiments computer system 10 may include modifications of these hardware components or their interconnections, or additional components, so the depicted example should not be construed as implying any architectural limitations with respect to the present invention. The invention may further be implemented in an equivalent cloud computing network.

When computer system 10 is initially powered up, service processor 32 uses JTAG interface 34 to interrogate the system (host) processors 12a, 12b and MC/HB 16. After completing the interrogation, service processor 32 acquires an inventory and topology for computer system 10. Service processor 32 then executes various tests such as built-in-self-tests (BISTs), basic assurance tests (BATs), and memory tests on the components of computer system 10. Any error information for failures detected during the testing is reported by service processor 32 to operator panel 42. If a valid configuration of system resources is still possible after taking out any components found to be faulty during the testing then computer system 10 is allowed to proceed. Executable code is loaded into memory 18 and service processor 32 releases host processors 12a, 12b for execution of the program code, e.g., an operating system (OS) which is used to launch applications and in particular the electric vehicle charging optimization application of the present invention, results of which may be stored in a hard disk drive of the system (an I/O device 24). While host processors 12a, 12b are executing program code, service processor 32 may enter a mode of monitoring and reporting any operating parameters or errors, such as the cooling fan speed and operation, thermal sensors, power supply regulators, and recoverable and non-recoverable errors reported by any of processors 12a, 12b, memory 18, and MC/HB 16. Service processor 32 may take further action based on the type of errors or defined thresholds.

The present invention may be a system, a method, and/or a computer program product. The computer program product may include one or more computer readable storage media collectively having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Computer system 10 carries out program instructions for an electric vehicle charging optimization process that uses novel analytical techniques to manage efficient vehicle recharging while en route to a destination. Accordingly, a program embodying the invention may additionally include conventional aspects of various autonomous systems and navigational tools, and these details will become apparent to those skilled in the art upon reference to this disclosure.

In some embodiments one or more functions of the optimization process can be carried out using cloud computing. It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include various characteristics, service models, and deployment models.

Characteristics can include, without limitation, on-demand service, broad network access, resource pooling, rapid elasticity, and measured service. On-demand self-service refers to the ability of a cloud consumer to unilaterally provision computing capabilities, such as server time and network storage, as needed automatically without requiring human interaction with the service's provider. Broad network access refers to capabilities available over a network and accessed through standard mechanisms that promote use by heterogeneous thin or thick client platforms (e.g., mobile phones, laptops, and personal digital assistants, etc.). Resource pooling occurs when the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter). Rapid elasticity means that capabilities can be rapidly and elastically provisioned, in some cases automatically, to quickly scale out and rapidly released to quickly scale in. To the consumer, the capabilities available for provisioning often appear to be unlimited and can be purchased in any quantity at any time. Measured service is the ability of a cloud system to automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models can include, without limitation, software as a service, platform as a service, and infrastructure as a service. Software as a service (SaaS) refers to the capability provided to the consumer to use the provider's applications running on a cloud infrastructure. The applications are accessible from various client devices through a thin client interface such as a web browser. The consumer does not manage or control the underlying cloud infrastructure including network, servers, operating systems, storage, or even individual application capabilities, with the possible exception of limited user-specific application configuration settings. Platform as a service (PaaS) refers to the capability provided to the consumer to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations. Infrastructure as a service (IaaS) refers to the capability provided to the consumer to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models can include, without limitation, private cloud, community cloud, public cloud, and hybrid cloud. Private cloud refers to the cloud infrastructure being operated solely for an organization. It may be managed by the organization or a third party and may exist on-premises or off-premises. A community cloud has a cloud infrastructure that is shared by several organizations and supports a specific community that has shared concerns (e.g., mission, security requirements, policy, and compliance considerations). It may be managed by the organizations or a third party and may exist on-premises or off-premises. In a public cloud, the cloud infrastructure is made available to the general public or a large industry group and is owned by an organization selling cloud services. The cloud infrastructure for a hybrid cloud is a composition of two or more clouds (private, community, or public) that remain unique entities but are bound together by standardized or proprietary technology that enables data and application portability (e.g., cloud bursting for load-balancing between clouds).

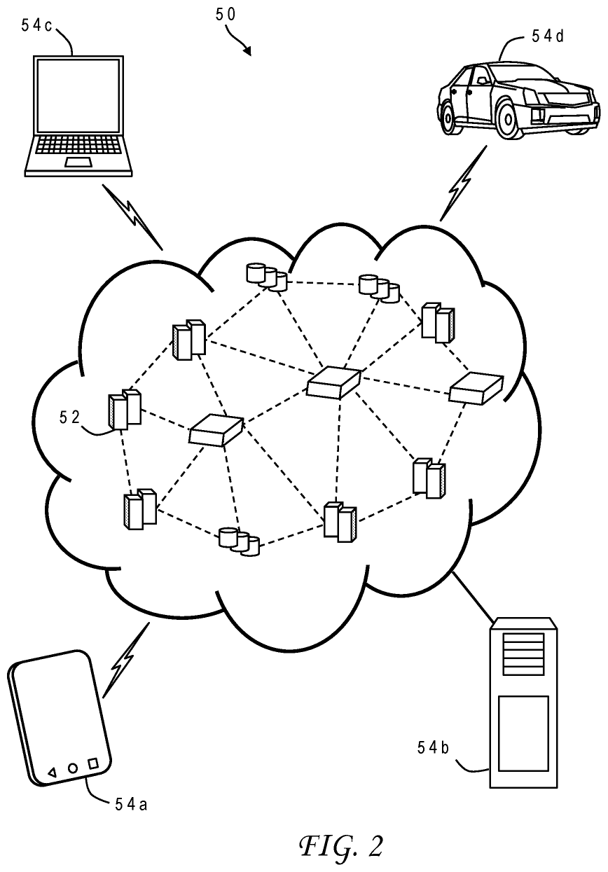

A cloud computing environment is service oriented with a focus on statelessness, low coupling, modularity, and semantic interoperability. At the heart of cloud computing is an infrastructure that includes a network of interconnected nodes. An illustrative cloud computing environment 50 is depicted in FIG. 2. As shown, cloud computing environment 50 includes one or more cloud computing nodes 52 with which local computing devices used by cloud consumers, such as, for example, personal digital assistant (PDA) or cellular telephone 54a, desktop computer 54b, laptop computer 54c, and/or automobile computer system 54d may communicate. Nodes 52 may communicate with one another. They may be grouped (not shown) physically or virtually, in one or more networks, such as private, community, public, or hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54a-54d shown in FIG. 2 are intended to be illustrative only and that computing nodes 52 and cloud computing environment 50 can communicate with any type of computerized device over any type of network and/or network addressable connection (e.g., using a web browser).

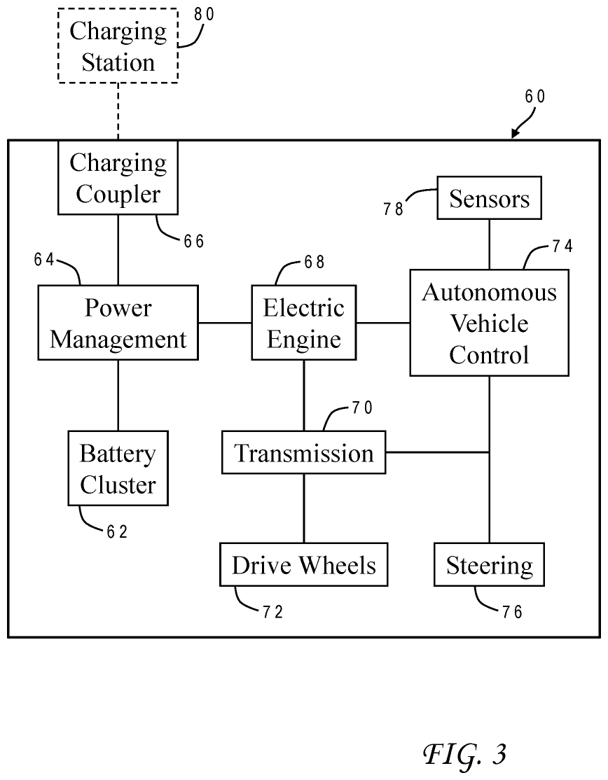

Referring now to FIG. 3, there is schematically depicted one configuration of a drive system 60 for an autonomous electric vehicle in accordance with the present invention. The autonomous electric vehicle may for example be automobile 54d of FIG. 2. Drive system 60 includes a battery cluster 62, a power management module 64, a charging coupler 66, an electric engine 68, a transmission 70, drive wheels 72, autonomous vehicle control 74, steering 76, and sensors 78. Electric engine 68 is powered from electricity provided by battery cluster 62 via power management module 64. Battery cluster 62 may be any conventional arrangement of rechargeable electricity storage devices. Power management module 64 regulates the power provided to electric engine 68 as well as oversees recharging of battery cluster 62.

Drive force from electric engine 68 is passed to drive wheels 72 via transmission 70 (e.g., torque coupling) to impel the car forward or backward according to the transmission settings made by autonomous vehicle control 74. Further direction of movement is achieved by steering 76 as operated by autonomous vehicle control 74. Autonomous vehicle control 74 receives various input data from sensors 78 to adjust control of electric engine 68 and steering 76 according to a predetermined navigational route. The input data affecting vehicle locomotion may include, among other things, the engine output (e.g., revolutions per minute), speed of the vehicle, acceleration, feedback from the steering system, compass heading, battery charge, and various safety devices. Other non-sensory inputs to autonomous vehicle control 74 may affect vehicle locomotion, such as operator-defined preferences (e.g., a maximum speed limit). Autonomous vehicle control 74 uses conventional techniques to manage the vehicle locomotion. Part of those computations may be carried out by a cloud server, e.g., one of the nodes 52 of FIG. 2. The cloud server may have any conventional construction, such as the computer system of FIG. 1.

Battery cluster 62 is recharged using charging coupler 66 which operably attaches to an external charging station 80. Charging station 80 may be a fixed station or a mobile station. Although charging station 80 could be a recharging unit located at an operator's home using a conventional wall outlet (level 1 or level 2 charging station), in the illustrative implementation recharging station 80 is a publically-available station located along or nearby an intended route of the vehicle (level 3 or DC fast charging). Power management module 64 monitors recharging as is known in the art to prevent overcharging, and provides an indication to the vehicle operator (i.e., lead passenger for an autonomous vehicle) once battery cluster 62 is fully recharged. In hybrid systems, battery cluster 62 may also be recharged by a generator driven by operation of a conventional internal combustion engine (not shown). The automobile may additionally have a braking mechanism (not shown) that converts a resistance force during deceleration into an electric force that allows power to be recovered by battery cluster 62.

It is understood that FIG. 3 illustrates only the drive system for the autonomous electric vehicle and it has many other systems and subsystems not shown such as heating/air conditioning systems, sound systems, or other entertainment systems. The details of such systems are known to those skilled in the art and are beyond the scope of the present disclosure.

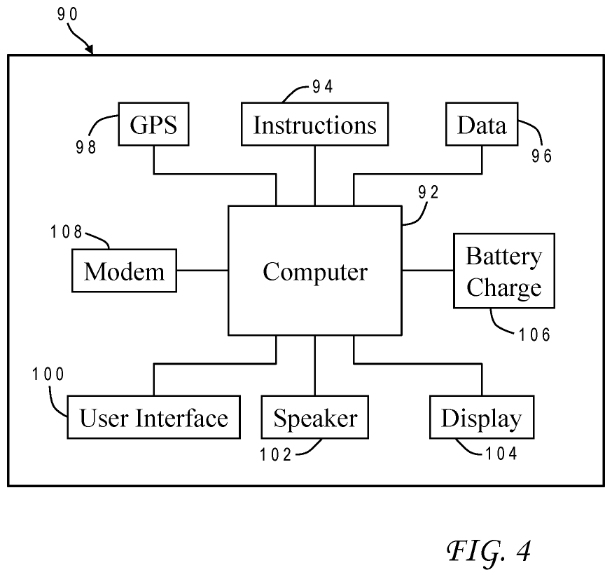

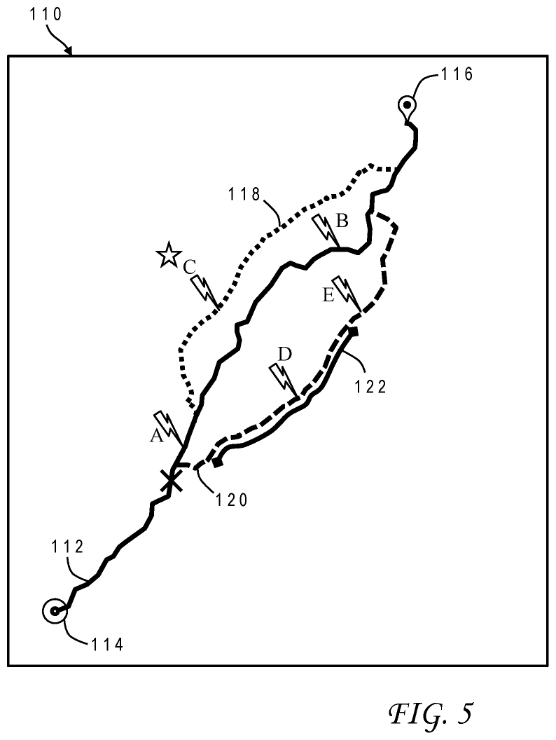

One other system used in the autonomous electric vehicle according to an exemplary embodiment is a navigation system. One implementation for such a navigation system 90 is seen in FIG. 4. At the heart of navigation system 90 lies a computer 92. Computer 92 may be similar to computer system 10 of FIG. 1 or may have an alternative (conventional) architecture. Computer 92 operates according to a set of program instructions 94 using operand data 96 which includes map (geographical) information. Data 96 may be stored in a storage device such as a permanent hard drive or solid-state memory device, or provided on a removable storage media such as a CD or DVD. Computer 92 receives inputs from a global positioning system (GPS) receiver 98 and a user interface 100. Among other functionalities, instructions 94 allow computer 92 to chart a proposed course or route for a vehicle from a starting location to a destination location. The starting location and destination location are entered by the operator via user interface 100 which may include a keypad or touch screen. User interface 100 may also include a microphone allowing computer 92 to interpret spoken navigational commands from the operator using voice recognition software. Computer 92 provides the proposed route to the operator via one or more graphical images on a display 102, along with other text information ancillary to the proposed route. Computer 92 may additionally provide audible driving instructions or other navigational information via a speaker 104. Navigational information from computer 92 can be provided as an input to autonomous vehicle control 74. Computer 92 receives information regarding the current battery charge 106 which is used to trigger a charging station check as explained further below in conjunction with FIG. 5. Computer 92 may include additional components such as a clock to keep track of the current time/date.

Computer 92 is in further contact with one or more outside services via a modem 108. Modem 108 provides wireless communications to, e.g., cell phone towers, Wi-Fi hot spots, or 5G cells. These communications extend to networks such as the Internet, which allow for additional functionalities to be provided via the cloud computing of FIG. 2. For some implementations, a cloud server collects information relevant to electric vehicle charging stations. The charging station information can include, without limitation, station location, station charging cost including any peak hour rates, hours of operation, and type (level) of charging available. The cloud server can also collect ancillary information relating to the station, such as a safety rating associated with the station location. Safety information may be provided by a third party service or can be gathered in a variety of ways such as from local law enforcement or sources of crime statistics. The charging station information is stored with data 96 and is regularly updated, preferably at least once a day.

Instructions 94 include programming to analyze potential charging stations along or near a proposed route according to different rules and parameters, and recommend alternate routes or detours in order to optimize charging of the autonomous electric vehicle as needed. While the vehicle is en route, computer 92 monitors battery charge 106 to make sure there is still some minimum charge left. For example, when the vehicle's battery is less than 25% of full capacity, computer 92 can initiate the charging station analysis. Computer 92 might recommend staying on the proposed route and stopping at a charging station along the way, or recommend deviating from the proposed route to use an alternate charging station. In the illustrative implementation the recommendation is based on (i) the relative cost savings of the alternate charging station based on the current time and applicable charging rate compared to using the reference charging station that is on the way, (ii) the extra distance required to drive to the alternate charging station (along a revised route) based on the current location of the electric vehicle, and (iii) the safety rating for the alternate charging station. Threshold values for any or all of these parameters can be set as constraints by the operator. For example, an operator might set the required cost savings to at least 5%, a maximum deviation distance of 10% of the proposed route (or some absolute number of miles), and a minimum safety rating of 3, where a safety rating of 1 is “most safe” and a safety rating of 5 is “least safe”.

As an alternative to providing a single recommendation based on all three of these values, computer 92 can make multiple recommendations based on just one value or a combination of two values, e.g., a first recommendation based only on cost savings and second recommendation based only on safety. There could be more complicated functions of these parameters to arrive at a positive decision to detour; an operator might be willing to go farther out of the way if there is even more cost savings. In some embodiments, additional factors can be taken into consideration. For example, the charging speed can be part of the calculation for the recommendation, which takes into account the elapsed time required to achieve a full charge of the batteries. A level 1 charging station (standard U.S. wall outlet) charges at a rate of about 1 kilowatt (kW). A level 2 charging station (typical home charging stations) charges at a rate somewhere between 7 kW and 19 kW. An older public charging station (level 3 or DCFC) might deliver 50 kW, and a state-of-the-art public fast-charging station might deliver 150 kW or more. An operator can specify a minimum charging rate or, alternatively, a maximum allowable time to recharge to justify a detour. The recharge time is dependent on the charging rate, the fully capacity of the battery, and the current charge of the battery (or a predicted charge by the time the vehicle arrives at the alternate station).

Advantageously, this analysis can be performed using edge computing. Edge computing is a distributed computing paradigm which brings computation and data storage closer to the location where it is needed, to improve response times and save bandwidth. The cloud servers provide the background information needed to plan alternate charging stations but since this information is downloaded to data 96 every day computer 92 can carry out the analysis nearly in real-time based on other current factors (time and location) which are generated local to the electric vehicle. If computer 92 determines that there is a more suitable charging location within the selection constraints, it sends the detour route information to autonomous vehicle control 74 with the alternate charging station designated as an intermediate stop, and informs the operator or otherwise seeks operator confirmation for the new route.

FIG. 5 provides an example of how the present invention might be deployed in accordance with one implementation. This example is depicted as a screenshot 110 from a navigation system (e.g., on display 104) of a road map showing a primary route 112 from a starting location 114 to a destination location 116. While the vehicle is en route at the spot in FIG. 5 marked with an “X”, the navigation system receives an alert that the battery power is less than 25% of capacity. It then identifies five possible charging stations that are on the primary route or nearby. The charging station locations are marked as small lightning bolts in FIG. 5 and labeled A-E. Charging stations A and B are on primary route 112, while charging station C is on a first alternate route 118, and charging stations D and E are on a second alternate route 120. Table 1 shows for each charging station in this example the cost in dollars per kilowatt hour, deviation distance in kilometers, and safety information on the previous 1-5 scale.

TABLE 1

| Station | Rate | Deviation | Safety |
|---|---|---|---|
| A | $4 per kWh | 0 km | 2 |
| B | $5 per kWh | 0 km | 1 |
| C | $3 per kWh | 1 km | 3 |
| D | $3 per kWh | 2 km | 2 |
| E | $2 per kWh | 2 km | 4 |

While charging stations A and B incur no extra distance since they are on primary route 112, they are the most expensive charging stations out of the five, i.e., charging stations C, D and E are all cheaper. Further to this example, the primary route distance is 30 km so all three of the charging stations C, D and E are within an acceptable range since their detour deviations are less than 10% of the total trip. Out of these three, charging station E has the lowest cost and would accordingly be the recommended location but for the fact that the operator has selected a maximum safety rating of three, and charging station E has a rating of 4, i.e., not safe enough. Charging station E is thus eliminated from the candidates, leaving charging stations C and D. Charging stations C and D have the same cost, but charging station C has less detour deviation than charging station D, so the navigation system selects charging station C as the recommended location as indicated in FIG. 5 by the star symbol, and the recommendation is provided to the operator. This recommendation is made even though charging station C has a worse safety rating (3) than charging station D (2) because the safety rating for charging station C is still within permissible limits and, for this implementation, cost is otherwise prioritized over safety.

In some embodiments where mobile refueling is available, it may be advantageous for the vehicle to leverage that convenience even at the expense of a longer route. FIG. 5 shows a roadway segment 122 (part of alternate route 120) along which a trailer rig operates than can convey the electric vehicle while charging it. This path is deemed preferable according to the operator constraints since it lowers the effective detour time and also results in the electric vehicle having a higher charge when arriving at destination location 118. This situation is another example of an opportunity to provide ad hoc engagements to the application for edge computing. The operator can be informed of the conveyance near the same route and uses vehicle-to-vehicle communications to arrange for the service. A cloud server can still provide information to the navigation system regarding the conveyances locations as well as availability of slots and charging capacities.

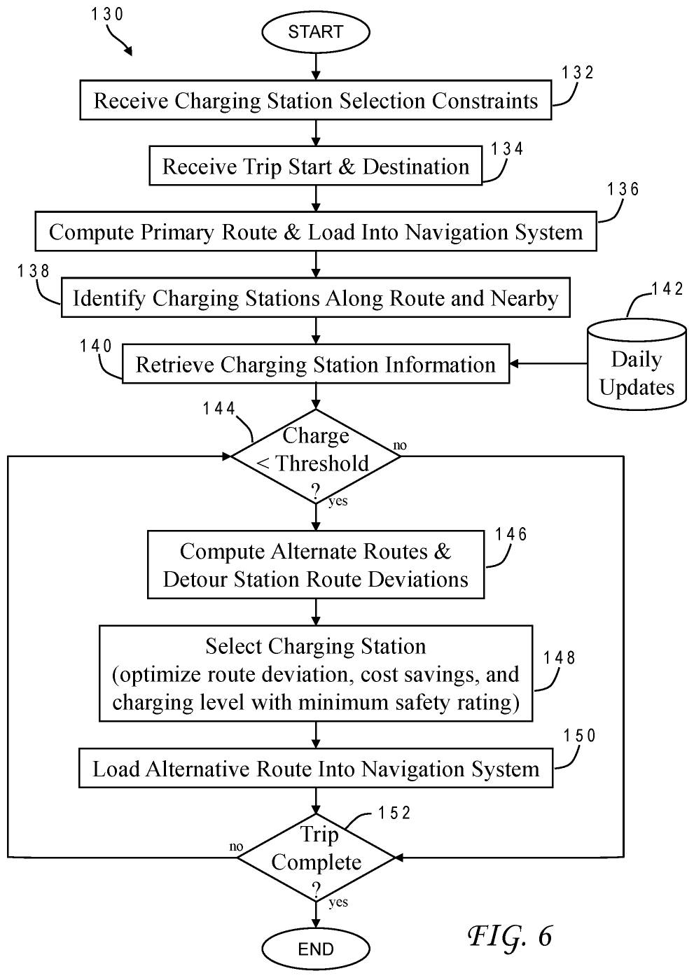

The present invention may be further understood with reference to the chart of FIG. 6 which illustrates the logical flow for an electric vehicle charging optimization process 130 in accordance with one implementation. Process 130, which may be carried out by a navigation system such as navigation system 90, begins by receiving the charging station selection constraints 132. The constraints may be preprogrammed, i.e., by default, or may be set by the operator, or by another owner of the vehicle. The system also receives the trip information, i.e., starting and destination locations 134. The navigation system computes an appropriate route using conventional algorithms and loads it 136. The navigation system can also identify any charging stations along the route or nearby in background processing 138. Charging station information is retrieved for each of the identified charging stations 140 so that is can be readily available in case further analysis is required. This information can be obtained via daily updates 142 from a cloud server. This information includes, for each charging station, a station location, a station charging cost, and a station safety rating. As noted above, additional information can be used in the charging optimization analysis for other implementations. The navigation system then monitors the vehicle battery charge to see if it falls below a minimum threshold 144. If so, the system responsively begins the charging optimization analysis by computing alternate routes and detour deviations for charging stations along the alternate routes 146. The alternate route deviations are used along with the charging station information to select an optimal charging station 148. There can be different priorities in the optimization depending upon designer implementation or user preference. The alternate route for the selected charging station is loaded into the navigation system 150, and the vehicle travels along the alternate route until it reaches the selected charging station and the battery is recharged. The process repeats iteratively at box 144 checking on the battery charge, until the trip is finally complete 152.

The present invention in its various implementations thereby provides a superior solution enabling self-driving electric cars to automatically and effortlessly identify the most optimal charging station that is still economical and safe for the passengers. The optimization leverages existing computing capabilities including edge technology and cloud computing to offer efficient data analysis for real-time or near real-time conditions.

Although the invention has been described with reference to specific embodiments, this description is not meant to be construed in a limiting sense. Various modifications of the disclosed embodiments, as well as alternative embodiments of the invention, will become apparent to persons skilled in the art upon reference to the description of the invention. For example, the invention has been described with reference to detour deviations based on a primary route that has start and stop points, but the deviations could instead be based on a revised route from the car's current location to the destination. The entire trip could also be optimized before it even begins rather than waiting for the battery charge to deplete. It is therefore contemplated that such modifications can be made without departing from the spirit or scope of the present invention as defined in the appended claims.

What is claimed is:

1. A method of optimizing a charging location for an electric vehicle during a trip comprising:
receiving a proposed route for the trip;
identifying a route charging station on the proposed route which has a reference charging cost;
identifying a plurality of detour charging stations proximate the proposed route;
receiving charging station information regarding each of the detour charging stations including a station location and a station charging cost;
receiving station selection constraints including an acceptable route deviation from the proposed route and a minimum cost savings compared to the reference charging cost;
monitoring the electric vehicle in real-time to determine that a current power charge is below a predetermined threshold when the electric vehicle is at a current location; and
selecting an optimal one of the detour charging stations for charging the electric vehicle based on the current location of the electric vehicle and the charging station information subject to the station selection constraints.

2. The method of claim 1 wherein the charging information further includes a station safety rating, and the selection constraints further include a minimum safety rating defined by an operator of the electric vehicle.

3. The method of claim 1 wherein said selecting includes:
determining a set of the detour charging stations whose station locations are within the acceptable route deviation based on the current location and whose station charging costs yield at least the minimum cost savings; and
choosing the optimal detour charging station as one of the detour charging stations in the set which has a lowest detour station charging cost.

4. The method of claim 3 wherein there are multiple stations in the set having the lowest detour station charging cost, and the optimal detour station has a station location with a lowest route deviation.

5. The method of claim 1 wherein the charging information further includes a station charging rate indicating how fast a given detour charging station recharges.

6. The method of claim 1 wherein the acceptable route deviation is a percentage of a distance of the proposed route.

7. The method of claim 1 wherein the minimum cost savings is a percentage of the reference charging cost.

8. A navigation system for an electric vehicle comprising:
one or more processors which process program instructions;
a memory device connected to said one or more processors; and
program instructions residing in said memory device for computing a proposed route for a trip, identifying a route charging station on the proposed route which has a reference charging cost, identifying a plurality of detour charging stations proximate the proposed route, receiving charging station information regarding each of the detour charging stations including a station location and a station charging cost, receiving station selection constraints including an acceptable route deviation from the proposed route and a minimum cost savings compared to the reference charging cost, monitoring the electric vehicle in real-time to determine that a current power charge is below a predetermined threshold when the electric vehicle is at a current location, and selecting an optimal one of the detour charging stations for charging the electric vehicle based on the current location of the electric vehicle and the charging station information subject to the station selection constraints.

9. The navigation system of claim 8 wherein the charging information further includes a station safety rating, and the selection constraints further include a minimum safety rating defined by an operator of the electric vehicle.

10. The navigation system of claim 8 wherein the selecting includes:
determining a set of the detour charging stations whose station locations are within the acceptable route deviation based on the current location and whose station charging costs yield at least the minimum cost savings; and
choosing the optimal detour charging station as one of the detour charging stations in the set which has a lowest detour station charging cost.

11. The navigation system of claim 10 wherein there are multiple stations in the set having the lowest detour station charging cost, and the optimal detour station has a station location with a lowest route deviation.

12. The navigation system of claim 8 wherein the charging information further includes a station charging rate indicating how fast a given detour charging station recharges.

13. The navigation system of claim 8 wherein the acceptable route deviation is a percentage of a distance of the proposed route.

14. The navigation system of claim 8 wherein the minimum cost savings is a percentage of the reference charging cost.

15. An autonomous electric vehicle comprising:
a locomotion system including an electric engine;
an autonomous control system which controls said locomotion system;
a rechargeable electric power source for said electric engine; and
a navigation system which computes a proposed route for a trip, identifies a route charging station on the proposed route which has a reference charging cost, identifies a plurality of detour charging stations proximate the proposed route, receives charging station information regarding each of the detour charging stations including a station location and a station charging cost, receives station selection constraints including an acceptable route deviation from the proposed route and a minimum cost savings compared to the reference charging cost, monitors the electric vehicle in real-time to determine that a current power charge is below a predetermined threshold when the electric vehicle is at a current location, and selects an optimal one of the detour charging stations for charging the electric vehicle based on the current location of the electric vehicle and the charging station information subject to the station selection constraints.

16. The autonomous electric vehicle of claim 15 wherein the charging information further includes a station safety rating, and the selection constraints further include a minimum safety rating defined by an operator of the electric vehicle.

17. The autonomous electric vehicle of claim 15 wherein said navigation system selects the optimal detour charging station by determining a set of the detour charging stations whose station locations are within the acceptable route deviation based on the current location and whose station charging costs yield at least the minimum cost savings, and choosing the optimal detour charging station as one of the detour charging stations in the set which has a lowest detour station charging cost.

18. The autonomous electric vehicle of claim 17 wherein there are multiple stations in the set having the lowest detour station charging cost, and the optimal detour station has a station location with a lowest route deviation.

19. The autonomous electric vehicle of claim 15 wherein the charging information further includes a station charging rate indicating how fast a given detour charging station recharges.

20. The autonomous electric vehicle of claim 15 wherein the acceptable route deviation is a percentage of a distance of the proposed route.
